(19) United States
(12) Patent Application Publication
(10) Pub. No.: US 2015/0173557 A1
(43) Pub. Date: Jun. 25, 2015

(54) TEA BAG STORAGE CASE FOR MINERAL WATER BOTTLE HAVING INTEGRATED CAP

(71) Applicants: Jung Yong JANG, Gyeonggi-do (KR); Beom Soo KIM, Incheon (KR); TEA UP CO., LTD., Seoul (KR)

(72) Inventor: Jung Yong JANG, Gyeonggi-do (KR)

(73) Assignees: TEA UP CO., LTD., Seoul (KR); Jung Yong JANG, Gyeonggi-do (KR); Beom Soo KIM, Incheon (KR)

(21) Appl. No.: 14/576,215

(22) Filed: Dec. 19, 2014

(30) Foreign Application Priority Data
Dec. 24, 2013 (KR) 10-2013-0162391

(51) Int. Cl. A47J 31/06; A47J 31/00; B65D 85/812

(52) U.S. Cl. CPC A47J 31/0636; B65D 85/812; A47J 31/005

(57) ABSTRACT

The tea bag storage case for the mineral water bottle includes: a main body which has a hollow inside and a cylindrical form of which both ends are closed, the main body including a cap member which has a screw thread formed on the inner circumferential surface of one side to be joined to an inlet of the mineral water bottle and a plurality of pores which are formed in the outer circumferential surface in the longitudinal direction; a tea member which is located inside the main body to make the ingredients infuse by water charged in the mineral water bottle; and a filter member which is hermetically attached to the pores to make water of the mineral water bottle move inside and outside the main body and prevents the tea member from escaping into the mineral water bottle through the pores.

### CROSS-REFERENCE TO RELATED APPLICATION

This application is based on and claims priority from Korean Patent Application No. 10-2013-0162391 filed on Dec. 24, 2013 in the Korean Intellectual Property Office, the disclosure of which is incorporated herein in its entirety by reference.

### BACKGROUND OF THE INVENTION

1. Field of the Invention

The present invention relates to a tea bag storage case for a mineral water bottle having an integrated cap, and more particularly, to a tea bag storage case for a mineral water bottle having an integrated cap which makes contents infuse in mineral water when a user removes a cap joined to the mineral water bottle and connects the tea bag storage case to the mineral water bottle instead of the removed cap so that the user can easily make beverages, such as green tea or coffee, and which is economical because it is disposable or is reusable when a tea bag is replaced with a new one, and which includes an indicating member which is attached to one side of the tea hag storage case and has a color corresponding to an insipid taste, a color corresponding to a normal taste and a color corresponding to a strong taste so that the user can select a wanted taste by comparing the color of water in which the contents of the tea bag infuse with the colors of the indicating member.

2. Background of the Related Art

For instance, in a case that a person climbs a mountain, he or she carries a small-sized mineral water bottle which contains mineral water to drink mineral water when he or she feels thirsty or carries a beverage bottle or a beverage can which contains a beverage, such as fruit drink, tea or coffee, to drink the beverage. In this instance, if the person carries just one kind of the beverage, the person cannot drink it according to the person's preference, but if the person carries more than two kinds of beverages, it costs a lot of money and it is difficult to climb the mountain carrying all of the beverages because the beverages are heavy. It is so with the case that a person drinks mineral water or beverages in everyday life.

Moreover, because the expiration dates of beverages are shorter than that of water, in a case that the beverages are stored for a long time, they may be spoiled, and hence, beverages have a disadvantage in that they need circulation expenses and storage expenses more than water.

### Prior Art Documents

Utility Model Document 1: Korean Utility Model Registration No. 20-0259252 (Registered on Dec. 18, 2001)

### SUMMARY OF THE INVENTION

Accordingly, the present invention has been made to solve the above-mentioned problems occurring in the prior arts, and it is an object of the present invention to provide a tea bag storage case for a mineral water bottle having an integrated cap which makes contents infuse in mineral water when a user removes a cap joined to the mineral water bottle and connects the tea bag storage case to the mineral water bottle instead of the removed cap so that the user can easily make beverages, such as green tea or coffee, and which is economical because it is disposable or is reusable when a tea bag is replaced with a new one, and which includes an indicating member which is attached to one side of the tea bag storage case and has a color corresponding to an insipid taste, a color corresponding to a normal taste and a color corresponding to a strong taste so that the user can select a wanted taste by comparing the color of water in which the contents of the tea bag infuse with the colors of the indicating member.

To accomplish the above object, according to the present invention, there is provided a tea hag storage case for a mineral water bottle having an integrated cap including: a main body which has a hollow inside and a cylindrical form of which both ends are closed, the main body including a cap member which has a screw thread formed on the inner circumferential surface of one side to be joined to an inlet of the mineral water bottle and a plurality of pores which are formed in the outer circumferential surface in the longitudinal direction, a tea member which is located inside the main body to make the ingredients infuse by water charged in the mineral water bottle; and a filter member which is hermetically attached to the pores to make water of the mineral water bottle move inside and outside the main body and prevents the tea member from escaping into the mineral water bottle through the pores.

According to the present invention, an indicating member is attached to one side of the main body so that a user can compare the infused degree of the ingredients of the tea member with colors of the indicating member.

According to the present invention, one end of the main body is openably closed by a lid which is screw-coupled with the main body or is closed by a synthetic resin film adhered on the main body by ultrasonic waves.

According to the present invention, the cap member is forcedly coupled to the main body.

As described above, the tea bag storage case for the mineral water bottle having the integrated cap makes the contents infuse in mineral water when a user removes a cap joined to the mineral water bottle and connects the tea bag storage case to the mineral water bottle instead of the removed cap, so that the user can easily make beverages, such as green tea or coffee. Moreover, the tea bag storage case is economical because it is disposable or is reusable when a tea bag is replaced with a new one. The tea bag storage case includes an indicating member which is attached to one side of the tea bag storage case and has a color corresponding to an insipid taste, a color corresponding to a normal taste and a color corresponding to a strong taste, so that the user can select a wanted taste by comparing the color of water in which the contents of the tea bag infuse with the colors of the indicating member.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of a tea bag storage case for a mineral water bottle having an integrated cap according to a preferred embodiment of the present invention;

FIG. 2 is an exploded perspective view of the tea bag storage case for the mineral water bottle having the integrated cap according to the preferred embodiment of the present invention; and

FIG. 3 is a view showing a used state of the tea bag storage case for the mineral water bottle having the integrated cap according o the preferred embodiment of the present invention.

### DETAILED DESCRIPTION OF THE PREFERRED EMBODIMENT

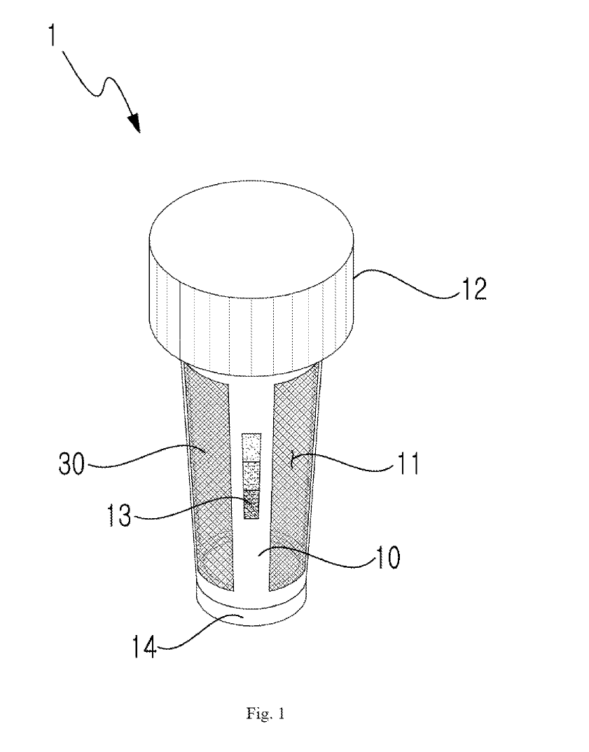

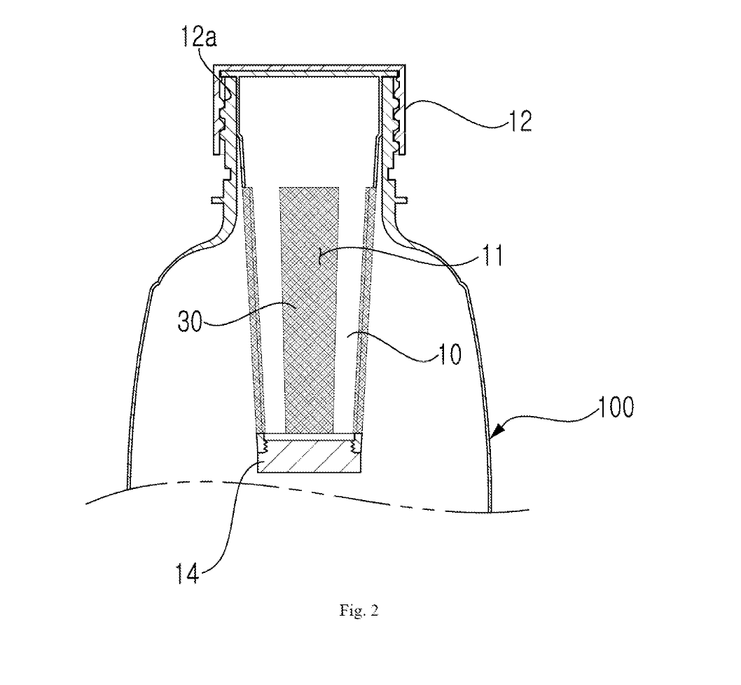

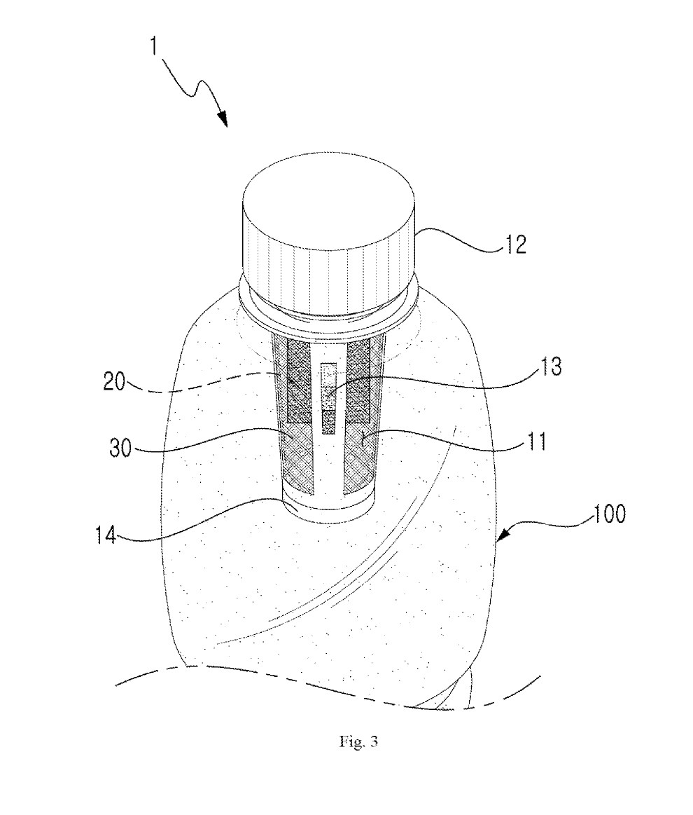

FIG. 1 is a perspective view of a tea bag storage case for a mineral water bottle having an integrated cap according to a preferred embodiment of the present invention, FIG. 2 is an exploded perspective view of the tea hag storage case for the mineral water bottle having the integrated cap according to the preferred embodiment of the present invention, and FIG. 3 is a view showing a used state of the tea bag storage case for the mineral water bottle having the integrated cap according to the preferred embodiment of the present invention.

The tea hag storage case for the mineral water bottle having the integrated cap according to the preferred embodiment of the present invention includes: a main body which has a hollow inside and a cylindrical form of which both ends are closed, the main body including a cap member which has a screw thread formed on the inner circumferential surface of one side to be joined to an inlet of the mineral water bottle and a plurality of pores which are formed in the outer circumferential surface in the longitudinal direction; a tea member which is located inside the main body to make the ingredients infuse by water charged in the mineral water bottle; and a filter member which is hermetically attached to the pores to make water of the mineral water bottle move inside and outside the main body and prevents the tea member from escaping into the mineral water bottle through the pores.

Hereinafter, referring to FIGS. 1 to 3, components and connection relations of the components of the tea bag storage case 1 for the mineral water bottle having the integrated cap according to the preferred embodiment of the present invention will be described in detail.

Here, the main body 10 is joined to an inlet side of a mineral water bottle 100 instead of a cap joined to the mineral water bottle 100 to serve as a cap for he mineral water bottle 100 and to store a tea member 20 therein. The main body 10 has a hollow inside and a cylindrical form of which both ends are closed, and includes: a cap member 12 which has a screw thread 12a formed on the inner circumferential surface of one side to be joined to an inlet of the mineral water bottle 100; and a plurality of pores 11 which are formed in the outer circumferential surface in the longitudinal direction.

The cap member 12 has the same size and material as the general caps for mineral water bottles 100 which are circulated on the market, and hence, can open and close the mineral water bottle 100 instead of the general caps for the mineral water bottles 100. A space portion is formed between the outer circumferential surface of the upper side of the main body 10 and the inner circumferential surface of the cap member 12, such that the inlet of the mineral water bottle 100 can be watertightly inserted. Furthermore, because the cap member 12 has the screw thread 12a formed on the inner circumferential surface thereof to be screw-coupled with the inner circumferential surface of the inlet of the mineral water bottle 100, a user can easily open and close the mineral water bottle 100 as occasion demands. Because the tea bag storage case for a mineral water bottle having an integrated cap can first prevent a water leak due to the inner circumferential surface of the inlet of the mineral water bottle 100 and the outer circumferential surface of the upper side of the main body 10 which get in close contact with each other and second prevent the water leak through screw-coupling between the outer circumferential surface of the inlet of the mineral water bottle 10 and the inner circumferential surface of the cap member 12, the tea bag storage case can keep a watertight state without any packing member. The cap member 12 is press-fit with the main body 10 and the cap member 12 and the main body 10 are made of a polypropylene material, and preferably, is vacuum-packed in a state where it is sterilized and sanitized.

Additionally, the pores 11 make water contained inside the mineral water bottle 100 flow to infuse ingredients of the tea member 20, and are hermetically by a filter member 30 which will be described later.

In addition, an indicating member 13 is attached to one side of the main body 10. The user can compare the infused degree of the ingredients of the tea member 20, which will be described later, with colors of the indicating member 13 so that the user can select the taste of the drink. That is, the indicating member 13 has colors of three stages: a color corresponding to an insipid taste; a color corresponding to a normal taste; and a color corresponding to a strong taste. Therefore, the user can compare the color of water changed during the infusion of the tea member 20 with the color of the indicating member 13 to select a wanted taste. The user separates the main body 10 from the mineral water bottle 100 using the cap member 12 when the color of water is changed into the color similar with the color of the wanted taste.

One end of the main body 10 is openably closed by a lid 14 which is screw-coupled with the main body 10 as described in the drawing, or is closed by a synthetic resin film adhered on the main body 10 by ultrasonic waves (not shown in the drawings). In the former case, it is preferable that the tea bag storage case be used for a tea bag type tea member 20 which is replaceable and reusable, but in the latter case, it is preferable that the tea bag storage case be used for a powder type tea member 20 which is not reusable.

In the meantime, the tea member 20 which is located inside the main body 10, makes the ingredients infuse by water of the mineral water bottle 100, so that the user can drink a beverage besides water. The tea member 20 may be one of tea leaves of various kinds, such as green, black tea, lemon tea, Chrysanthemum tea and corn silk tea. In this embodiment of the present invention, tea leaves are used, but tea bags in which various tea leaves are stored, tea powder, coffee powder or water-soluble foaming tablet type cold medicines or vitamins may be used.

Meanwhile, the filter member 30 is hermetically attached on the pores 11 of the main body 10 in which the tea member 20 is stored. The filter member 30 serves as a filter which makes water of the mineral water bottle 100 move inside and outside the main body 10 and prevents the tea member 20 from escaping into the mineral water bottle 100 through the pores 11. The filter member 30 may have large-sized holes in the case that the tea member 20 is used, but it is preferable that the filter member 30 have fine holes to prevent powder from escaping from the filter member 30 in the case that powder is used.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. A tea bag storage case for a mineral water bottle having an integrated cap comprising:
a main body which has a hollow inside and a cylindrical form of which both ends are closed, the main body including a cap member which has a screw thread formed on the inner circumferential surface of one side to be joined to an inlet of the mineral water bottle and a plurality of pores which are formed in the outer circumferential surface in the longitudinal direction;
a tea member which is located inside the main body to make the ingredients infuse by water charged in the mineral water bottle; and
a filter member which hermetically attached to the pores to make water of the mineral water bottle move inside and outside the main body and prevents the tea member from escaping into the mineral water bottle through the pores.

2. The tea bag storage case for the mineral water bottle according to claim 1, wherein a space portion is formed between the outer circumferential surface of the upper side of the main body and the inner circumferential surface of the cap member, such that the inlet of the mineral water bottle can be watertightly inserted.

3. The tea bag storage case for the mineral water bottle according to claim 1, wherein an indicating member is attached to one side of the main body so that a user can compare the infused degree of the ingredients of the tea member with colors of the indicating member.

4. The tea bag storage case for the mineral water bottle according to claim 1, wherein one end of the main body is operably closed by a lid which is screw-coupled with the main body or is closed by a synthetic resin film adhered on the main body by ultrasonic waves.

5. The tea bag storage case for the mineral water bottle according to claim 1, wherein the cap member is forcedly coupled to the main body.
